(19) United States
(12) Patent Application Publication
(10) Pub. No.: US 2025/0125563 A1
(43) Pub. Date: Apr. 17, 2025

(54) CONNECTOR

(71) Applicant: SUMITOMO WIRING SYSTEMS, LTD., Mie (JP)

(72) Inventor: Takurou KAWAI, Mie (JP)

(21) Appl. No.: 18/908,086

(22) Filed: Oct. 7, 2024

(30) Foreign Application Priority Data
Oct. 12, 2023 (JP) 2023-176743

(51) Int. Cl. H01R 13/639; H01R 13/42; H01R 13/506; H01R 13/627

(52) U.S. Cl. CPC H01R 13/639; H01R 13/42; H01R 13/506; H01R 13/6273

(57) ABSTRACT

A connector includes a housing including a tubular peripheral wall and a retainer to be mounted into the housing. The peripheral wall includes a mounting opening, through which the retainer is mounted, in an end part in a direction of an axis of the peripheral wall. The retainer is configured to be mountable into and removable from inside of the peripheral wall through the mounting opening. The retainer includes a hooking portion, to which a tip of a rod-like jig for removing the retainer from the inside of the peripheral wall is hookable. The peripheral wall includes a jig insertion hole penetrating through the peripheral wall. The tip of the jig is hookable to the hooking portion through the jig insertion hole.

### CROSS-REFERENCE TO RELATED APPLICATIONS

This application is based on and claims priority from Japanese Patent Application No. 2023-176743, filed on Oct. 12, 2023, with the Japan Patent Office, the disclosure of which is incorporated herein in its entirety by reference.

### TECHNICAL FIELD

The present disclosure relates to a connector.

### BACKGROUND

For example, Japanese Patent Laid-open Publication No. 2005-322488 describes a connector provided with a housing including a tubular peripheral wall and a retainer to be mounted into the housing. The peripheral wall of the housing includes a mounting opening in an end part of an axial direction of the peripheral wall. The retainer is configured to be mountable into and removable from the inside of the peripheral wall through the mounting opening. A mating connector is fit into the mounting opening. The retainer includes a hooking portion, to which the tip of a rod-like jig can be hooked. In removing the retainer from the inside of the peripheral wall, the jig is inserted into the inside of the peripheral wall through the mounting opening and the tip of this jig is hooked to the hooking portion. The retainer can be pulled out from the inside of the peripheral wall by a lever operation of the jig with the peripheral edge of the mounting opening as a fulcrum.

### SUMMARY

In the retainer of the connector as described above, the hooking portion needs to be set in a range where the inserted jig reaches an opening of the peripheral wall. This has been a factor of reducing a degree of design freedom of the retainer.

The present disclosure aims to provide a connector capable of improving a degree of design freedom of a retainer.

The present disclosure is directed to a connector with a housing including a tubular peripheral wall, and a retainer to be mounted into the housing, the peripheral wall including a mounting opening in an end part in an axial direction of the peripheral wall, the retainer being mounted through the mounting opening, the retainer being configured to be mountable into and removable from inside of the peripheral wall through the mounting opening, the retainer including a hooking portion, a tip of a rod-like jig for removing the retainer from the inside of the peripheral wall being hookable to the hooking portion, the peripheral wall including a jig insertion hole penetrating through the peripheral wall, and the tip of the jig being hookable to the hooking portion through the jig insertion hole.

According to the connector of the present disclosure, a degree of design freedom of the retainer can be improved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector in one embodiment.

FIG. 2 is a perspective view of a housing and a retainer in the embodiment.

FIG. 3 is a section of the connector in the embodiment.

FIG. 4 is a side view of the connector in the embodiment.

FIG. 5 is a section along 5-5 in FIG. 4.

FIG. 6 is a section along 6-6 in FIG. 4.

FIG. 7 is a section showing a mode of removing the retainer in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

Embodiments of the present disclosure are first listed and described.
[1] The connector of the present disclosure is provided with a housing including a tubular peripheral wall, and a retainer to be mounted into the housing, the peripheral wall including a mounting opening in an end part in an axial direction of the peripheral wall, the retainer being mounted through the mounting opening, the retainer being configured to be mountable into and removable from inside of the peripheral wall through the mounting opening, the retainer including a hooking portion, a tip of a rod-like jig for removing the retainer from the inside of the peripheral wall being hookable to the hooking portion, the peripheral wall including a jig insertion hole penetrating through the peripheral wall, and the tip of the jig being hookable to the hooking portion through the jig insertion hole.

According to this configuration, the rod-like jig can be inserted into the inside of the peripheral wall through the jig insertion hole from the outer peripheral side of the peripheral wall and the tip thereof can be hooked to the hooking portion of the retainer. The retainer can be pulled out from the inside of the peripheral wall, for example, by a lever operation of the jig with a peripheral edge of the jig insertion hole as a fulcrum. According to this configuration, a position where the hooking portion can be set in the retainer is not limited to that near the mounting opening. In this way, a degree of design freedom of the retainer can be improved.
[2] In [1] described above, the peripheral wall includes a reinforcement rib projecting from the peripheral edge of the jig insertion hole toward an outer peripheral side of the peripheral wall, and if, out of both end parts of the jig insertion hole in the axial direction of the peripheral wall, the one close to the mounting opening is a first end part and the one distant from the mounting opening is a second end part, the reinforcement rib is provided at least on a peripheral edge of the second end part in the jig insertion hole.

According to this configuration, the rigidity of at least the second end part of the jig insertion hole can be improved by the reinforcement rib. Therefore, the lever operation of the jig with the second end part of the jig insertion hole as a fulcrum can be stably performed.
[3] In [1] or [2] described above, if, out of both end parts of the jig insertion hole in the axial direction of the peripheral wall, the one close to the mounting opening is a first end part and the one distant from the mounting opening is a second end part, an inner peripheral surface of the second end part in the jig insertion hole is formed with an inclined surface inclined toward the outer peripheral side of the peripheral side.

According to this configuration, operability when the lever operation of the jig is performed with the second end part in the jig insertion hole as a fulcrum can be improved, with the result to that a contribution can be made to the improvement of workability in removing the retainer.
[4] In any one of [1] to [3] described above, the housing includes a terminal accommodation block inside the peripheral wall, the retainer includes an inner peripheral wall for surrounding the terminal accommodation block inside the peripheral wall, the inner peripheral wall includes the hooking portion and a locking piece to be locked to the terminal accommodation block in the axial direction of the peripheral wall, and the hooking portion and the locking piece are provided side by side with each other in the axial direction of the peripheral wall.

According to this configuration, a force for releasing the locking of the locking piece to the terminal accommodation block can be generated by the lever operation of the jig in removing the retainer. Therefore, the releasability of the locking piece from the terminal accommodation block can be improved. As a result, a contribution can be made to the improvement of workability in removing the retainer.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each drawing. X, Y and Z axes orthogonal to each other are shown in each figure. Further, “perpendicular” in this specification means not only strictly perpendicular, but also substantially perpendicular within a range in which functions and effects in this embodiment are achieved.

Note that a term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Further, the “tubular” shapes include circular shapes, elliptical shapes and polygonal shapes with angular or rounded corners. Further, a term “annular” used in the description of this specification generally indicates an arbitrary structure forming a loop, a continuous shape free from an end part or a general loop-shaped structure including a gap such as a C shape. Note that “annular” shapes include circular shapes, elliptical shapes and polygonal shapes with angular or round corners, but there is no limitation to these. Further, “facing each other” in this specification indicates that surfaces or members are at positions in front of each other, and means not only a case where the surfaces or members are at positions perfectly in front of each other, but also a case where the surfaces or members are at positions partially in front of each other. Further, “facing each other” in this specification means both a case where another member different from two parts is interposed between the two parts and a case where nothing is interposed between the two parts. Further, terms such as “first” and “second” in this specification are merely used to distinguish objects and do not rank the objects. Note that the present invention is not limited to these illustrations, but is represented by claims and intended to include all changes in the scope of claims and in the meaning and scope of equivalents.

### (Connector 10)

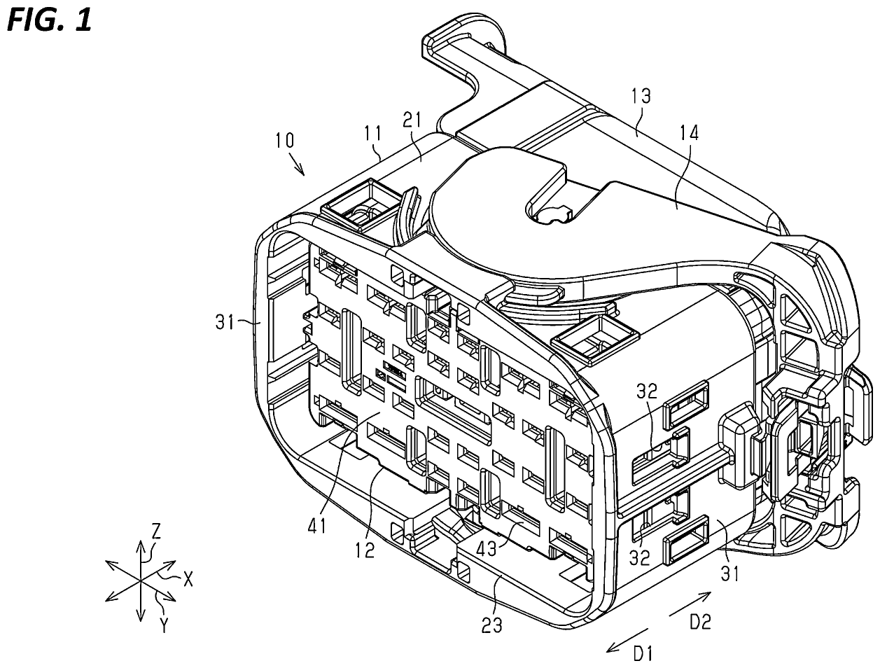

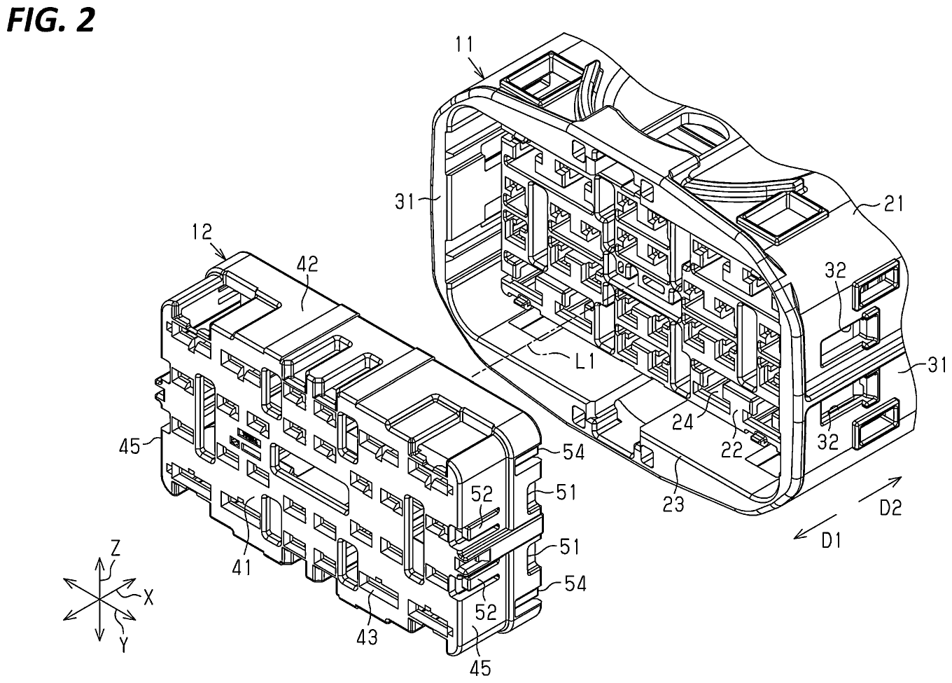

A connector 10 shown in FIG. 1 is connected to an unillustrated electrical device installed in a vehicle. The connector 10 is provided with a housing 11 and a retainer 12 to be mounted into the housing 11. The housing 11 and the retainer 12 are, for example, made of synthetic resin. The housing 11 is connected to an unillustrated mating connector provided on the electrical device in a first direction D1 along the X axis. Note that, in the following description, a direction opposite to the first direction D1 along the X axis is called a second direction D2. The connector 10 includes, for example, a cover 13 for covering an end part in the second direction D2 of the housing 11 and a lever 14 for assisting the connection of the housing 11 to the mating connector. In FIG. 2 and subsequent figures, the cover 13 and the lever 14 are not shown in the housing 11.

### (Housing 11)

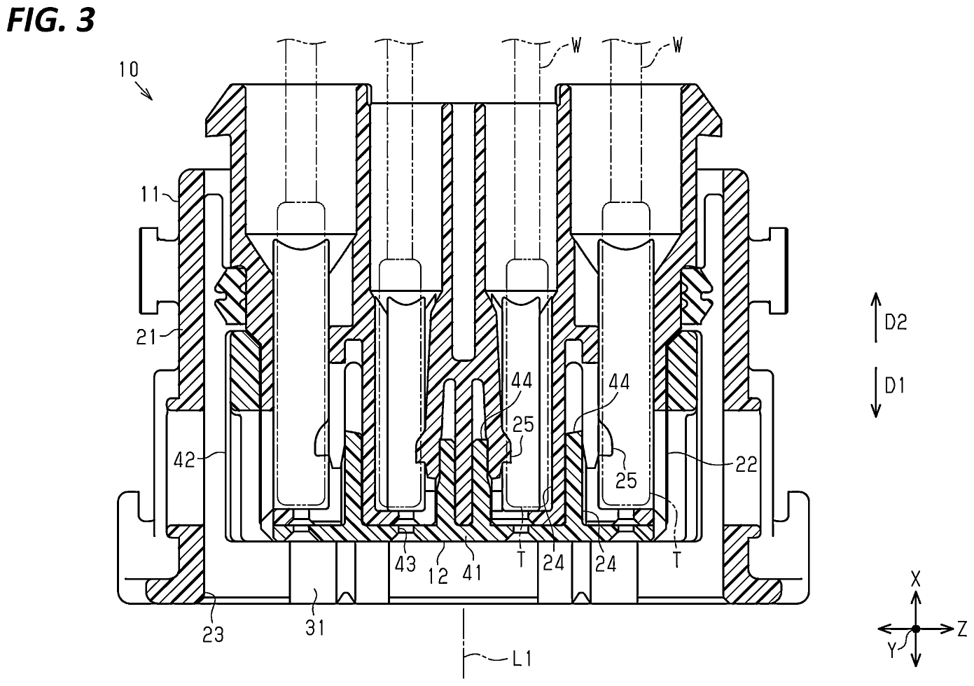

As shown in FIGS. 2 and 3, the housing 11 includes a tubular peripheral wall 21 and a terminal accommodation block 22 located inside the peripheral wall 21. The peripheral wall 21 has an annular shape centered on an axis L1 of the peripheral wall 21 along the X axis. The peripheral wall 21 has, for example, a rectangular tube shape when viewed from the second direction D2. Further, the terminal accommodation block 22 has, for example, a rectangular tube shape when viewed from the second direction D2.

The peripheral wall 21 has a mounting opening 23 in an end part of the peripheral wall 21 in a direction of the axis L1. The mounting opening 23 is provided in an end part in the first direction D1 of the peripheral wall 21. Note that, in the following description, the first direction D1 may be referred to as a forward direction and the second direction D2 may be referred to as a rearward direction. That is, the mounting opening 23 is provided in a front end part of the peripheral wall 21. Further, the mounting opening 23 is open forward (in the first direction D1). The mating connector is fit into the inside of the peripheral wall 21 of the housing 11 through the mounting opening 23.

As shown in FIG. 3, the terminal accommodation block 22 includes a plurality of terminal accommodation holes 24 penetrating through the terminal accommodation block 22 along the X axis. A terminal T is accommodated into each terminal accommodation hole 24. A wire W connected to each terminal T is drawn out in the second direction D2 from the housing 11. A locking lance 25 for locking the terminal T is provided inside each terminal accommodation hole 24. At the time of mounting the terminal T, the terminal T is inserted into the terminal accommodation hole 24 in the first direction D1. At this time, the locking lance 25 locks the terminal T by resiliently returning to an initial position after being temporarily deflected in a Z-axis direction due to contact with the terminal T. The terminal T is locked by the locking lance 25, thereby being prevented from coming out in the second direction d2.

### (Jig Insertion Holes 32)

As shown in FIG. 2, the peripheral wall 21 of the housing 11 includes a pair of side wall portions 31 facing each other in a Y-axis direction. Each side wall portion 31 forms a part of the peripheral wall 21. The terminal accommodation block 22 is located between the pair of side wall portions 31 in the Y-axis direction. The side wall portion 31 is provided with jig insertion holes 32 penetrating through this side wall portion 31. The jig insertion hole 32 penetrates through the side wall portion 31, for example, in a direction orthogonal to the axis L1. The jig insertion hole 32 penetrates through the peripheral wall 21 to allow communication between a space on an inner peripheral side and a space on an outer peripheral side of the peripheral wall 21.

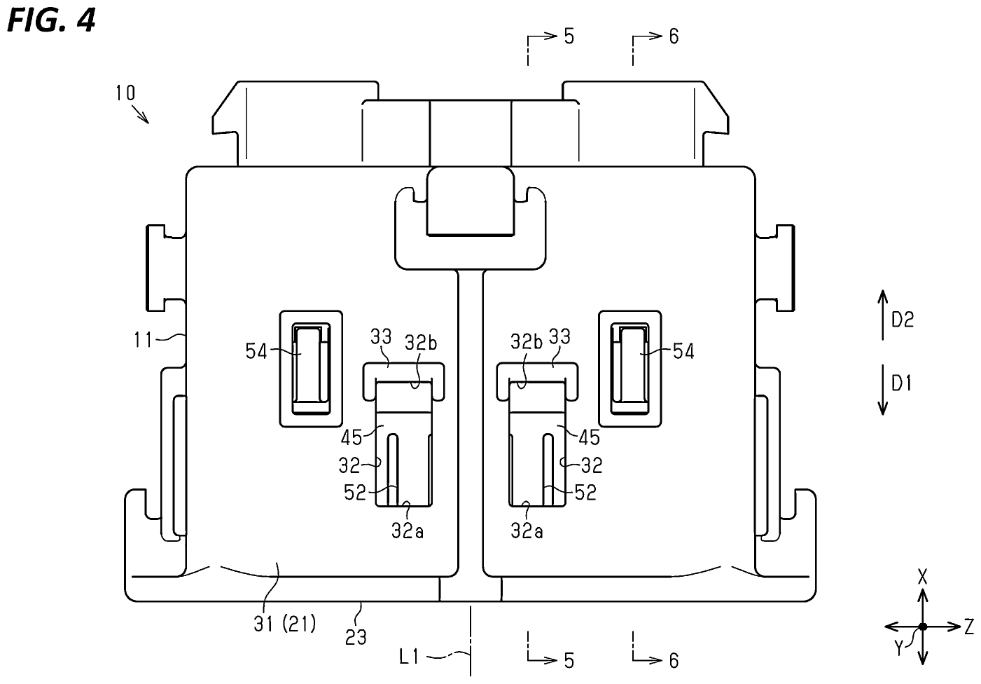

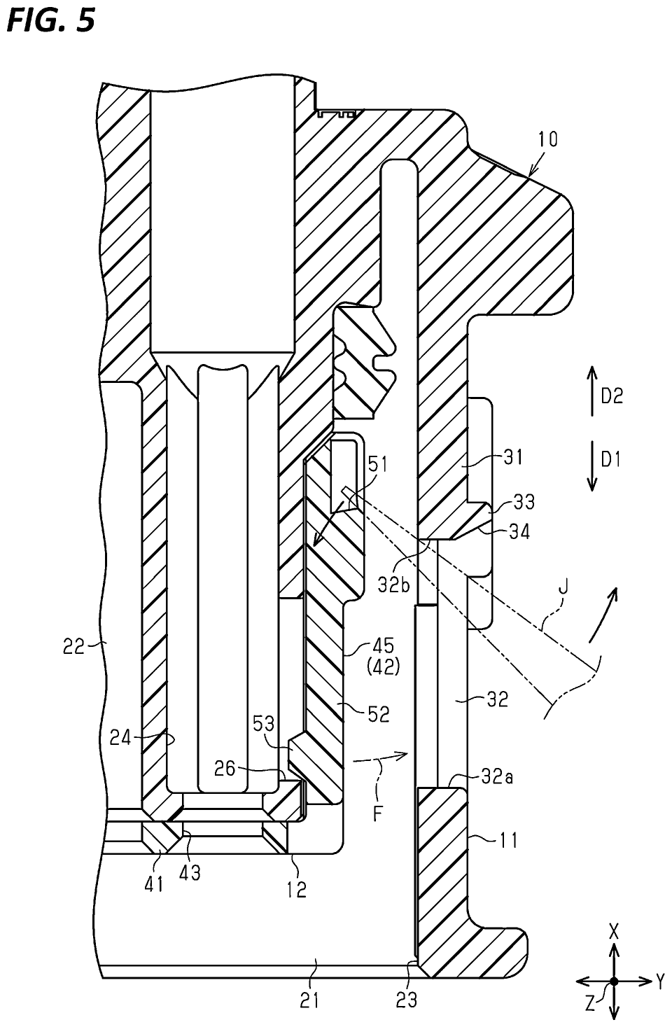

As shown in FIGS. 4 and 5, the jig insertion hole 32 penetrates through the side wall portion 31 in the Y-axis direction. The jig insertion holes 32 are, for example, provided in each of the pair of side wall portions 31. Further, two jig insertion holes 32 are, for example, provided in each of the pair of side wall portions 31. The respective jig insertion holes 32 have, for example, the same shape.

The jig insertion hole 32 has, for example, a quadrangular shape when viewed from the Y-axis direction. More particularly, the jig insertion hole 32 has a rectangular shape extending along the X axis when viewed from the Y-axis direction. The jig insertion hole 32 has a first end part 32a and a second end part 32b, which are both end parts in the direction of the axis L1. Out of the both end parts of the jig insertion hole 32 in the direction of the axis L1, the first end part 32a is an end part close to the mounting opening 23 and the second end part 32b is an end part distant from the mounting opening 23.

As shown in FIGS. 4 and 5, the peripheral wall 21 of the housing 11 includes reinforcement ribs 33 projecting from the peripheral edges of the jig insertion holes 32 toward outer peripheral sides of the side wall portions 31. The reinforcement rib 33 is, for example, provided only on a part of the peripheral edge of the jig insertion hole 32. Specifically, the reinforcement rib 33 is provided on the peripheral edge of the second end part 32b in the jig insertion hole 32. The reinforcement rib 33 projects in the Y-axis direction from the peripheral edge of the second end part 32b in the jig insertion hole 32. The reinforcement rib 33 is, for example, formed over the entire region of the second end part 32b in the Z-axis direction. Further, both end parts in the Z-axis direction of the reinforcement rib 33 somewhat extend in the first direction D1 along the peripheral edge of the jig insertion hole 32.

As shown in FIG. 5, an inclined surface 34 inclined rearward (in the second direction D2) toward the outer peripheral side of the peripheral wall 21 is formed on the inner peripheral surface of the second end part 32b in the jig insertion hole 32. The inclined surface 34 is, for example, formed from an intermediate part in a thickness direction of the side wall portion 31 (intermediate part in the Y-axis direction) to a tip part of the reinforcement rib 33.

### (Retainer 12)

As shown in FIGS. 2 and 3, the retainer 12 is configured to be mountable into and removable from the terminal accommodation block 22 located inside the peripheral wall 21 through the mounting opening 23. Note that the retainer 12 is assembled with the terminal accommodation block 22 in the second direction D2 and removed therefrom in the first direction D1. The retainer 12 has a front wall 41 and an inner peripheral wall 42 extending from the front wall 41. The front wall 41 is, for example, in the form of a flat plate perpendicular to the X axis. The front wall 41 covers the terminal accommodation block 22 from front. The front wall 41 includes through holes 43 at positions respectively corresponding to the plurality of terminal accommodation holes 24 in the terminal accommodation block 22. Each through hole 43 penetrates through the front wall 41 in an X-axis direction. A terminal of the mating connector fit inside the peripheral wall 21 of the housing 21 is inserted into the terminal accommodation hole 24 through the through hole 43 and connected to the terminal T in the terminal accommodation hole 24.

As shown in FIG. 3, the front wall 41 includes restricting portions 44 for restricting the deflection of the locking lances 25. The restricting portions 44 are provided at positions respectively corresponding to a plurality of the locking lances 25. The restricting portion 44 restricts the deflection of the locking lance 25 by being inserted on a back surface side of the locking lance 25. In this way, the terminal T is suppressed from coming out in the second direction D2.

The inner peripheral wall 42 of the retainer 12 has an annular shape when viewed from the first direction D2. The inner peripheral wall 42 is arranged inside the peripheral wall 21 in the housing 11 and surrounds the outer periphery of the terminal accommodation block 22.

As shown in FIGS. 2 and 5, the inner peripheral wall 42 of the retainer 12 includes a pair of wall portions 45 facing each other in the Y-axis direction. Each wall portion 45 forms a part of the inner peripheral wall 42. The wall portion 45 is arranged between the terminal accommodation block 22 and the side wall portion 31 in the Y-axis direction. That is, the wall portion 45 of the retainer 12 is facing the side wall portion 31 of the housing 11 in the Y-axis direction.

### (Hooking Portions 51)

As shown in FIG. 5, the wall portion 45 in the inner peripheral wall 42 of the retainer 12 includes hooking portions 51, to which the tip of a rod-like jig J for removing the retainer 12 from the inside of the peripheral wall 21 can be hooked. The hooking portion 51 is, for example, formed by recessing the outer side surface of the wall portion 45. The hooking portion 51 is configured such that the tip of the jig J is hooked to the hooking portion 51 from rear toward front. Not a dedicated jig prepared according to the shape of the connector 10, but a general jig such as a flathead driver can be used as the jig J.

Two hooking portions 51 are provided in one wall portion 45 to correspond to the number of the jig insertion holes 32 provided in one side wall portion 31. Further, the hooking portions 51 are, for example, provided in each of the pair of wall portions 45. Two hooking portions 51 are, for example, provided in each of the pair of wall portions 45. The respective hooking portions 51 have, for example, the same shape (see FIG. 2).

### (Locking Pieces 52)

As shown in FIG. 5, the wall portion 45 in the inner peripheral wall 42 of the retainer 12 includes locking pieces 52 to be locked to the terminal accommodation block 22 in the direction of the axis L1 of the peripheral wall 21 (X-axis direction). The locking piece 52 is shaped to extend in the first direction D1. The locking piece 52 is formed to be deflectable in the Y-axis direction. The locking piece 52 includes a locking protrusion 53 projecting inward in the Y-axis direction. The locking protrusion 53 is locked to a locked portion 26 provided in the terminal accommodation block 22 in the first direction D1. In this way, the retainer 12 is held at a complete fixing position with respect to the housing 11. Note that FIGS. 1, 3, 4 and 5 show a state where the retainer 12 is held at the complete fixing position.

The hooking portion 51 and the locking piece 52 are provided side by side with each other in the direction of the axis L1 of the peripheral wall 21 (X-axis direction). The tip of the locking piece 52 is facing in the first direction D1, and the base end of the locking piece 52 and the locking portion 51 are arranged in the X-axis direction. That is, the hooking portion 51 is provided behind the base end of the locking piece 52.

Two locking pieces 52 are provided in one wall portion 45 to correspond to the number of the hooking portions 51 provided in one wall portion 45. Further, the locking pieces 52 are, for example, provided in each of the pair of wall portions 45. Two locking pieces 52 are, for example, provided in each of the pair of wall portions 45. That is, the retainer 12 includes a total of four locking pieces 52. The respective locking pieces 52 have, for example, the same shape.

In removing the retainer 12 at the complete fixing position from the housing 11, the jig J is inserted into the inside of the peripheral wall 21 through the jig insertion hole 32 in the housing 11 and the tip of the jig J is hooked to the hooking portion 51 of the retainer 12. The hooking portion 51 of the retainer 12 and the jig insertion hole 32 of the housing 11 are provided at the same position in the Z-axis direction. Further, when the retainer 12 is at the complete fixing position, the hooking portion 51 is located rearward of the second end part 32b of the jig insertion hole 32.

As shown in FIG. 2, the wall portion 45 in the inner peripheral wall 42 of the retainer 12 includes temporary hold locking portions 54 to be locked to the terminal accommodation block 22 in the first direction D1. The temporary hold locking portions 54 are, for example, provided side by side with the hooking portions 51 in the Z-axis direction. Two temporary hold locking portions 54 are, for example, provided in each of the pair of wall portions 45. That is, the retainer 12 includes a total of four temporary hold locking portions 54. The respective temporary hold locking portions 54 have, for example, the same shape.

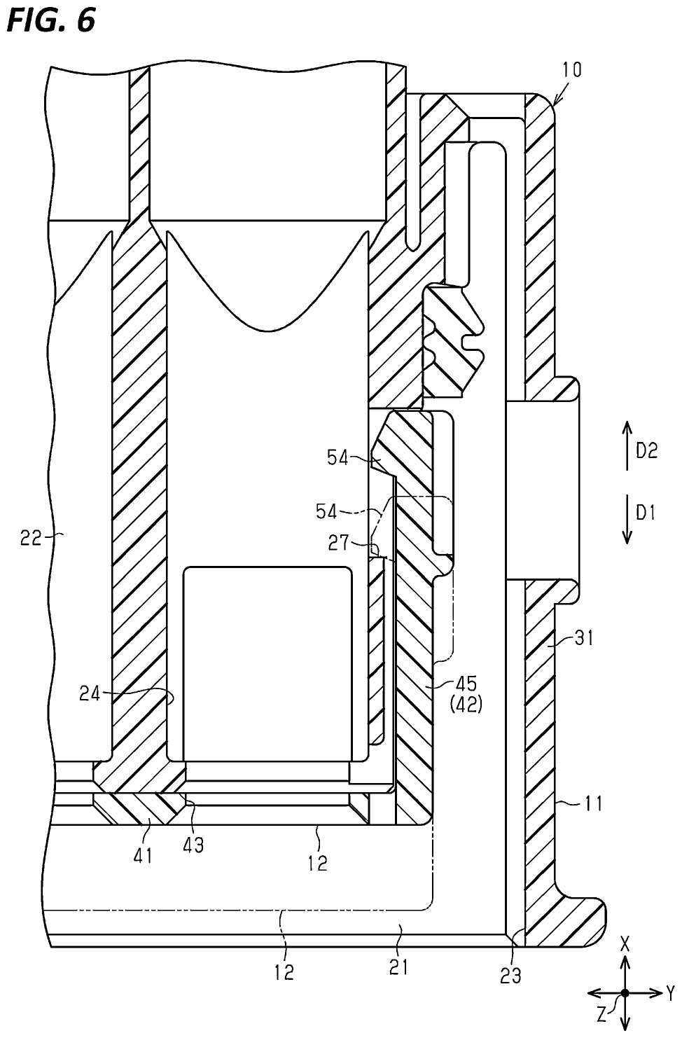

As shown in FIG. 6, the temporary hold locking portions 54 are locked to temporary hold locked portions 27 provided in the terminal accommodation block 22 in the first direction D1, whereby the retainer 12 is held at a temporary holding position with respect to the housing 11. Note that the retainer 12 at the complete fixing position is shown by solid line and the retainer 12 at the temporary holding position is shown by two-dot chain line in FIG. 6. The retainer 12 held at the temporary holding position is located forward (further in the first direction D1) of the complete fixing position. With the retainer 12 held at the temporary holding position, the restricting portions 44 of the retainer 12 are not inserted on the back surface sides of the locking lances 25 in the terminal accommodation block 22, whereby the locking lances 25 are allowed to be deflected. Therefore, with the retainer 12 held at the temporary holding position, the terminals T can be mounted into the terminal accommodation holes 24.

Functions of this embodiment are described.

In mounting the retainer 12 on the terminal accommodation block 22 of the housing 11, the retainer 12 is inserted into the inside of the peripheral wall 21 in the second direction D2. At this time, the temporary hold locking portions 54 of the retainer 12 are first locked to the terminal accommodation block 22, whereby the retainer 12 is held at the temporary holding position. With the retainer 12 held at the temporary holding position, the terminal T is mounted into the terminal accommodation hole 24 in the terminal accommodation block 22. Since the deflection of the locking lance 25 is allowed with the retainer 12 held at the temporary holding position, the locking lance 25 can be locked to the terminal T by the deflection of the locking lance 25.

After each terminal T is mounted into each terminal accommodation hole 24, the retainer 12 at the temporary holding position is pushed in the second direction D2. Then, by locking the locking pieces 52 of the retainer 12 to the locked portions 26 of the terminal accommodation block 22, the retainer 12 is held at the complete fixing position. With the retainer 12 held at the complete fixing position, the deflection of the locking lances 25 is restricted by the restricting portions 44 of the retainer 12. In this way, the terminals T are suppressed from coming out in the second direction D2.

In removing the retainer 12 from the housing 11, the retainer 12 is pulled out in the second direction D2, using the jig J. At this time, the jig J is inserted into the inside of the peripheral wall 21 through the jig insertion hole 32 from the outer peripheral side of the peripheral wall 21, and the tip of the jig J is hooked to the hooking portion 51 of the retainer 12. Then, a forward force is applied to the hooking portion 51 by a lever operation of the jig J with the second end part 32b of the jig insertion hole 32 as a fulcrum as shown by a solid-line arrow of FIG. 5.

Here, the force applied to the hooking portion 51 from the jig J also includes a component acting inward in the Y-axis direction. If a force acting inward in the Y-axis direction is applied to the hooking portion 51, a moment force is generated to deform a part of the wall portion 45 forward of the hooking portion 51 outward in the Y-axis direction. That is, a force F displacing outward in the Y-axis direction with respect to the locking piece 52 is generated. This force F is a force to be applied to the locked portion 26 in a direction to release the locking of the locking piece 52. Therefore, at the same time as the forward force is given to the hooking portion 51 by the lever operation of the jig J, the locking of the locking piece 52 is easily released by the force F.

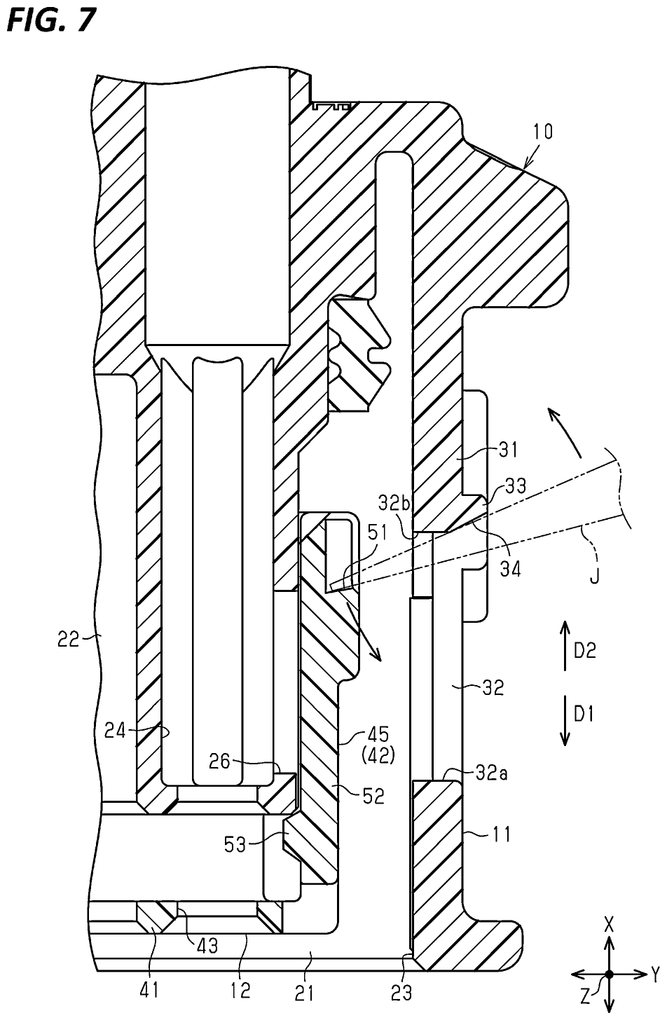

By applying the forward force to the retainer 12 by the lever operation of the jig J described above, the locking of the locking piece 52 to the locking portion 26 is released and the retainer 12 moves further forward than the complete fixing position shown in FIG. 5. FIG. 7 shows, for example, a moved state of the retainer 12 from the complete fixing position to the temporary holding position. In this state, by moving the retainer 12 further forward than the complete fixing position, a positional relationship of the hooking portion 51 and the second end part 32b of the jig insertion hole 32 serving as a fulcrum of the lever operation of the jig J changes and the inclination of the lever-operated jig J also changes. Here, since the inclined surface 34 formed on the inner peripheral surface of the second end part 32b in the jig insertion hole 32 is inclined along the inclination of the jig J, workability in removing the retainer 12 by the lever operation of the jig J is improved. Then, by releasing the locking of the temporary hold locking portions 54 to the terminal accommodation block 22, the retainer 12 can be removed in the first direction D1.

Effects of this embodiment are described.
(1) The peripheral wall 21 of the housing 11 includes the jig insertion holes 32 penetrating through the peripheral wall 21. According to this configuration, the rod-like jig J can be inserted into the inside of the peripheral wall 21 through the jig insertion hole 32 from the outer peripheral side of the peripheral wall 21, and the tip of the jig J can be hooked to the hooking portion 51 of the retainer 12. For example, by the lever operation of the jig J with the peripheral edge of the jig insertion hole 32 as a fulcrum, the retainer 12 can be pulled out from the inside of the peripheral wall 21. According to the above configuration, a position where the hooking portion 51 can be set in the retainer 12 is not limited to that near the mounting opening 23. In this way, a degree of design freedom of the retainer 12 can be improved.
(2) The peripheral wall 21 of the housing 11 includes the reinforcement ribs 33 projecting from the peripheral edges of the jig insertion holes 32 toward the outer peripheral side of the peripheral wall 21. Out of the both end parts of the jig insertion hole 32 in the direction of the axis L1 of the peripheral wall 21, the one near the mounting opening 23 is the first end part 32a and the one distant from the mounting opening 23 is the second end part 32b. The reinforcement rib 33 is provided at least on the peripheral edge of the second end part 32b in the jig insertion hole 32. According to this configuration, the rigidity of at least the second end part 32b of the jig insertion hole 32 can be improved by the reinforcement rib 33. Therefore, the lever operation of the jig J with the second end part 32b of the jig insertion hole 32 as a fulcrum can be stably performed.
(3) The inner peripheral surface of the second end part 32b in the jig insertion hole 32 is formed with the inclined surface 34 inclined toward the outer peripheral side of the peripheral wall 21. According to this configuration, operability when the lever operation of the jig J is performed with the second end part 32b in the jig insertion hole 32 as a fulcrum can be improved, with the result that a contribution can be made to the improvement of workability in removing the retainer 12.
(4) The housing 11 is provided with the terminal accommodation block 22 inside the peripheral wall 21. The retainer 12 includes the inner peripheral wall 42 for surrounding the terminal accommodation block 22 inside the peripheral wall 21. The inner peripheral wall 42 includes the hooking portions 51 and the locking pieces 52 to be locked to the terminal accommodation block 22 in the direction of the axis L1 of the peripheral wall 21. The hooking portion 51 and the locking piece 52 are provided side by side with each other in the direction of the axis L1 of the peripheral wall 21. According to this configuration, the force F for releasing the locking of the locking piece 52 to the terminal accommodation block 22 can be generated by the lever operation of the jig J in removing the retainer 12. Therefore, the releasability of the locking piece 52 from the terminal accommodation block 22 can be improved. As a result, a further contribution can be made to the improvement of workability in removing the retainer 12.

### Other Embodiments

The above embodiment can be modified and carried out as follows. The above embodiment and the following modifications can be carried out in combination without technically contradicting each other.
In the retainer 12 of the above embodiment, the hooking portion 51 and the locking piece 52 may not be arranged side by side with each other in the direction of the axis L1 of the peripheral wall 21 (X-axis direction).
In the housing 11 of the above embodiment, the inclined surface 34 may be omitted from the inner peripheral surface of the jig insertion hole 32.
In the housing 11 of the above embodiment, the reinforcement rib 33 may be provided over the entire peripheral edge of the jig insertion hole 32. Further, the reinforcement ribs 33 may be omitted in the housing 11 of the above embodiment.
The number of the jig insertion holes 32 in the peripheral wall 21 of the housing 11 is not limited to that in the above embodiment, but can be changed as appropriate according to the configuration of the connector 10.
The number of the hooking portions 51 in the retainer 12 is not limited to that in the above embodiment, but can be changed as appropriate according to the configuration of the connector 10.
The number of the locking pieces 52 in the retainer 12 is not limited to that in the above embodiment, but can be changed as appropriate according to the configuration of the connector 10.
The number of temporary hold locking portions 54 in the retainer 12 is not limited to that in the above embodiment, but can be changed as appropriate according to the configuration of the connector 10.
The jig J for removing the retainer 12 from the housing 11 is not limited to the flathead driver. That is, something other than the flathead driver can be used as the jig J if it can be inserted into the jig insertion hole 32 and hooked to the hooking portion 51 of the retainer 12.
The embodiment disclosed this time is illustrative in all aspects and the present invention is not limited to these illustrations. That is, the scope of the present invention is represented by claims and intended to include all changes in the scope of claims and in the meaning and scope of equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing including a tubular peripheral wall; and
a retainer to be mounted into the housing,
the peripheral wall including a mounting opening in an end part in an axial direction of the peripheral wall, the retainer being mounted through the mounting opening,
the retainer being configured to be mountable into and removable from inside of the peripheral wall through the mounting opening,
the retainer including a hooking portion, a tip of a rod-like jig for removing the retainer from the inside of the peripheral wall being hookable to the hooking portion,
the peripheral wall including a jig insertion hole penetrating through the peripheral wall, and
the tip of the jig being hookable to the hooking portion through the jig insertion hole.

2. The connector of claim 1, wherein:
the peripheral wall includes a reinforcement rib projecting from a peripheral edge of the jig insertion hole toward an outer peripheral side of the peripheral wall, and
if, out of both end parts of the jig insertion hole in the axial direction of the peripheral wall, the one close to the mounting opening is a first end part and the one distant from the mounting opening is a second end part, the reinforcement rib is provided at least on a peripheral edge of the second end part in the jig insertion hole.

3. The connector of claim 1, wherein if, out of both end parts of the jig insertion hole in the axial direction of the peripheral wall, the one close to the mounting opening is a first end part and the one distant from the mounting opening is a second end part, an inner peripheral surface of the second end part in the jig insertion hole is formed with an inclined surface inclined toward an outer peripheral side of the peripheral side.

4. The connector of claim 1, wherein:
the housing includes a terminal accommodation block inside the peripheral wall,
the retainer includes an inner peripheral wall for surrounding the terminal accommodation block inside the peripheral wall,
the inner peripheral wall includes the hooking portion and a locking piece to be locked to the terminal accommodation block in the axial direction of the peripheral wall, and
the hooking portion and the locking piece are provided side by side with each other in the axial direction of the peripheral wall.
